(19) United States
(12) Patent Application Publication
(10) Pub. No.: US 2013/0006872 A1
(43) Pub. Date: Jan. 3, 2013

(54) NEAR-FIELD COMMUNICATION BASED PAYMENT METHODS

(76) Inventors: Madhuri CHANDOOR, San Jose, CA (US); Nicolas Groleau, Mountain View, CA (US)

(21) Appl. No.: 13/171,838

(22) Filed: Jun. 29, 2011

(51) Int. Cl. G06Q 30/00; G06Q 20/00; H04L 9/28

(52) U.S. Cl. 705/75; 705/26.1; 705/64

(57) ABSTRACT

A method of performing a payment transaction is provided. Transaction information is received from a payee, which has been provided to the payee by a payor using near-field communications and includes a payment amount and payee account information. A transaction authentication request is sent to the payor, and, after a transaction authentication is received from the payor, the payment amount is sent to the payee. After the payment has been completed, a payment confirmation is sent to the payor. A method for processing a payment transaction using a generated remittance key is also provided. The remittance key, which includes an encrypted alphanumeric key having a payment amount and payment provider account information for a payor, is generated and transmitted to a payee who, in turn, transmits the remittance key to a remittance agent. The remittance agent transmits the remittance key and a payment request to a payment provider who processes the request and transmits a payment to the payee.

### BACKGROUND

1. Technical Field

Embodiments disclosed herein are related to processing financial transactions between parties. In particular, embodiments disclosed herein are related to providing wallet-free payments between a payor and a payee by a payment provider using near-field communication capabilities of a payor's mobile device.

2. Related Art

As modern technology evolves, the capabilities of today's devices seem almost limitless. For example, the ever-expanding capabilities of modern smart phones, tablet computers, laptop computers and notebook computers, have integrated these processing devices into people's daily lives making them nearly indispensible to their users. In many cases, the programs and applications that are executed on these processing devices are used to assist users in the management of their daily lives. For some, this has become a burden, but for many others, it has become a convenience. Moreover, the miniaturization of modern processing devices has allowed users to have greater processing power in the palms of their hands. What was once the laptop computer of a few years ago is now found in a smart phone, and what was once the desktop computer is now found in a tablet computer. As a result, users are taking these mobile devices with them everywhere, and using these devices to assist in managing their lives.

One area in which modern mobile devices has not seen substantial growth is in payment processing. Typically, when a person walks into a store to purchase an item, the person will still have to use traditional means of currency, such as personal checks, credit/debit card, or cash to complete a purchase. Thus, there is still a need to carry around a wallet or purse having these traditional means of currency as well as a mobile device. Often, a payor may leave their residence and be out shopping but not have their wallet, purse, cash, or their credit card available for use either through forgetfulness or to save space in their pocket or purse. However, as modern mobile devices become more integrated into our daily lives, it is often the case that a person will have their mobile device with them.

Accordingly, there is a need for a payment system that can be implemented with a mobile device and can alleviate the need to always carry around traditional means of currency.

### SUMMARY

Consistent with some embodiments, a method performed by a processor is provided. The method includes the steps of receiving transaction information from a payee, the transaction information provided to the payee by a payor using near-field communications and including a payment amount and payee account information, sending a transaction authentication request to the payor, receiving a transaction authentication from the payor, sending the payment amount to the payee, and sending a payment confirmation to the payor.

Consistent with some embodiments, a method performed by a processor of a mobile device is provided. The method includes the steps of initiating a payment transaction to a payee, selecting information related to the payment transaction for transmission, transmitting information related to the payment transaction to the payee, wherein the information is transmitted using near field communication (NFC) capabilities of the mobile device, authorizing a payment provider to perform the payment transaction in response to a authentication request received from the payment provider, and receiving, at the mobile device, a confirmation of the payment transaction from the payment provider.

Further consistent with some embodiments, there is also provided a non-transitory computer readable medium having instructions for execution by a processor, the instructions causing the processor, when executed, to perform a method including the steps of generating a remittance key, the remittance key including an encrypted alphanumeric key having a payment amount and payment provider account information for a payor. The method also includes the steps of transmitting the remittance key to a payee, and transmitting a payment amount to a remittance agent in response to a payment request received from the remittance agent, the payment request including the remittance key transmitted from the payee to the remittance agent using near field communications.

These and other embodiments will be described in further detail below with respect to the following figures.

### BRIEF DESCRIPTION OF THE FIGURES

FIG. 1 is a block diagram of a system for facilitating and performing financial transactions, consistent with some embodiments.

FIG. 2 is a diagram illustrating a device that may correspond to the user/payor device or merchant/POS device shown in FIG. 1, consistent with some embodiments.

FIG. 3 is a flowchart illustrating a method for conducting a payment transaction using near-field communications, consistent with some embodiments.

FIG. 4 is a flowchart illustrating a method for paying a payee consistent with some embodiments.

FIG. 5 is a flowchart illustrating a method for receiving payment from a payor, consistent with some embodiments.

FIG. 6 is a block diagram of a system for facilitating and performing financial transactions, such as a payment between a payor and a payee through the use of a remittance agent, consistent with some embodiments.

FIG. 7 is a flowchart illustrating a method for remitting a payment to a payee using a remittance agent, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

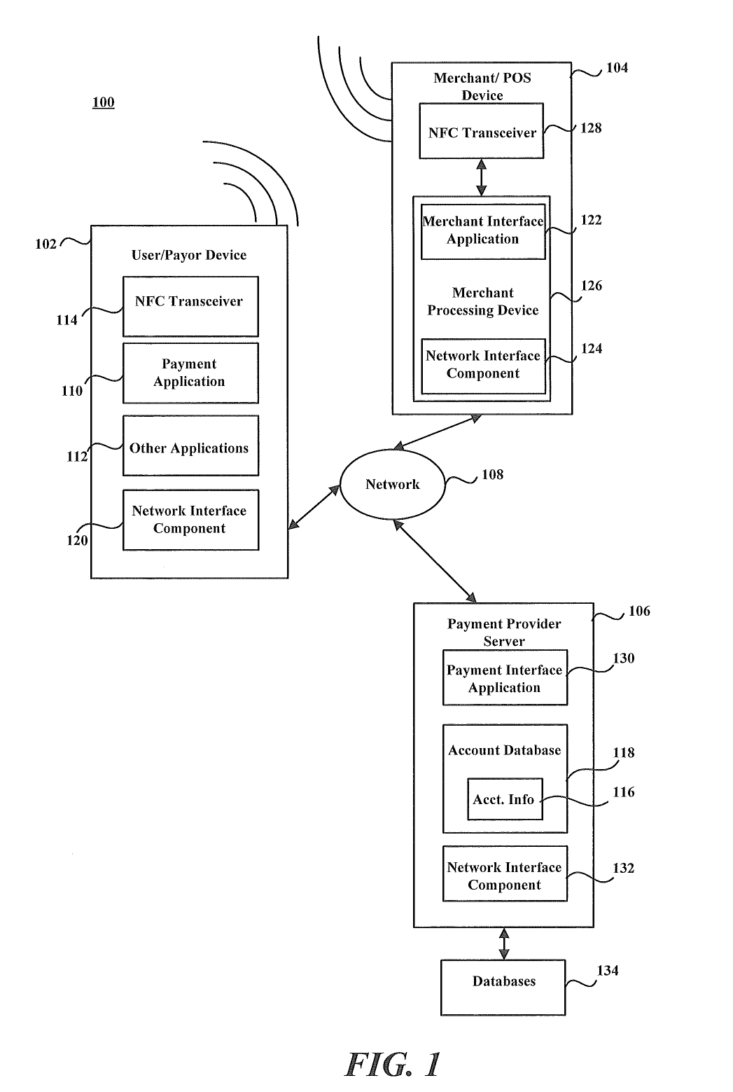

FIG. 1 is a block diagram of a system for facilitating and performing financial transactions, such as a payment between a payor and a payee, consistent with some embodiments. As shown in FIG. 1, system 100 includes a user/payor device 102, a merchant or point of sale (POS) device 104, and a payment provider server 106 all coupled to network 108. Throughout, payor or payor device may be used interchangeably with user or user device 102 and payee or payee device may be used interchangeably with merchant, POS, or merchant/POS device 104. Consistent with some embodiments, network 108 may be implemented as a single network or a combination of multiple networks. Network 108 may include a wireless telecommunications network adapted for communication with one or more other communication networks, such as the Internet. Network 108 may also include the Internet, one or more intranets, landline networks, wireless networks, and other communication networks. Consequently, user device 102, merchant/POS device 104, and payment provider server 106 may each be associated with a particular internet protocol (IP) address.

Consistent with some embodiments, user device 102 may include any appropriate combination of hardware and/or software having a processor and capable of reading instructions stored on a non-transitory machine-readable medium for execution by the processor. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read. Further, user device 102 may be configured for wired and/or wireless communication over network 108. According to some embodiments, user device 102 may be a mobile device, such as a mobile phone, a smart phone, or a tablet computer such as the Apple™ iPad™. According to other embodiments, user device 102 may be a processing device such as a personal computer, a personal digital assistant (PDA), or a notebook computer. User device 102 may be also referred to as a client device, a customer device, a mobile device, or a payor device, without departing from the scope of the present disclosure.

Consistent with some embodiments user device 102 includes a machine-readable medium, such as a memory (not shown) that includes instructions for execution by a processor (not shown) for causing user device 102 to perform specific tasks. For example, such instructions may include a payment application 110 and other applications 112.

Consistent with some embodiments, payment application 110 may be utilized by a user to conduct network-based financial transactions, (e.g., remote network-based commerce, such as shopping, purchasing, bidding, etc.) with a remote merchant device 104 or payment provider serve 106 over network 108. Consistent with other embodiments, payment application 110 may be utilized by a user to conduct financial transactions, such as a payment, with merchant/POS device 104 receiving a near-field communication (NFC) transmission sent from NFC transceiver 114. Consistent with some embodiments, user device 102 may be linked to an account 116 stored in an account database 118 on payment provider server 106 for the direct and/or automatic payment or exchange of funds between a payor and a payee.

According to some embodiments, payment application 110 includes instructions for execution by a processor, such as a software program, application, or “app”, that provides a graphical user interface (GUI) for interfacing and communicating with user as well as merchant/POS device 104 via network 108 or NFC Transceiver 114, and payment provider server 106 over network 108. Consistent with some embodiments, payment application 110 may allow a user to enter recipient payment information, user account information or log in information to access the user's account information 116, a payment amount, a user's credit card or bank account information, or other related information that may permit a payor to make a payment to a payee through payment service provider 106.

User device 102 further includes a network interface component (NIC) 120 configured for communication with network 108. Consistent with some embodiments, NIC 120 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 120 may be configured to interface with a digital subscriber line (DSL) modem, a public switched telephone network (PSTN) modem, an Ethernet device, and/or various other types of wired and/or wireless network communication devices adapted for communication with network 108.

Similar to user device 102, merchant/POS device 104 may include any appropriate combination of hardware and/or software having a processor and capable of reading instructions stored on a machine-readable medium for execution by the processor. According to some embodiments, merchant/POS device 104 may be a mobile device, such as a mobile phone, a smart phone, or a tablet computer such as the Apple™ iPad™. According to other embodiments, merchant/POS device 104 may be a processing device such as a personal computer, a personal digital assistant (PDA), or a notebook computer. According to further embodiments, merchant device 104 may be an application-specific machine, configured to perform a specific application, such as a POS workstation or checkout station, such as available from NCR Corp. of Duluth, Ga. Accordingly, merchant/POS device 104 includes at least a merchant interface application 122 and a network interface component 124 that is part of merchant processing device 126, wherein network interface component 124, in part, provides communications over network 108. Moreover, merchant/POS device further includes an NFC transceiver 128 for transmitting/receiving communications transmitted using an NFC protocol. As shown in FIG. 1, NFC transceiver 128 is coupled to merchant processing device 126. However, consistent with some embodiments, NFC transceiver 128 may also be included in merchant processing device 126. Further consistent with some embodiments, NFC transceiver 128 may be integrated into a personal identification number (PIN) pad and merchant processing device 126 may be a point of sale device.

Merchant interface application 122 may be used by a merchant or operator of merchant/POS device 104 to conduct and/or facilitate transactions. Moreover, merchant interface application 122 may include instructions, that when executed by a processor, perform communications to payment provider server 106 over network 108 for the purpose of receiving payments from payment provider server 106. For example, a merchant having merchant/POS device 104 may have an account stored in account database 118 of payment provider server 106 such that when a user authorizes a payment to be provided to merchant, payment provider facilitates the payment of funds to the merchant's account. Merchant interface application 122 may further allow for interaction with a user through NFC transceiver 128 to assist in conducting a transaction.

Merchant/POS device 104 further includes a network interface component (NIC) 126 configured for communication with network 108. Consistent with some embodiments, NIC 126 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 126 may be configured to interface with a digital subscriber line (DSL) modem, a public switched telephone network (PSTN) modem, an Ethernet device, and/or various other types of wired and/or wireless network communication devices adapted for communication with network 108.

Payment provider server 106, according to some embodiments, may be maintained by an online transaction processing entity, which may provide processing for online financial transactions and/or information transactions between user device 102 and merchant/POS device 104, may include any appropriate combination of hardware and/or software having a processor and capable of reading instructions stored on a machine-readable medium for execution by the processor. In particular, payment provider server 106 may include a payment interface application 130 which may be configured to interact with user device 102, merchant/POS device 104, and other devices over network 108 to facilitate the payment between one or more users/merchants. Consistent with some embodiments, payment provider server 106 may be provided by PayPal, Inc. and/or eBay of San Jose, Calif., USA.

Payment interface application 130 may include a payment processing module to process payments of purchases for financial transactions between a payor and a payee, such as between a payor using user device 102 and a payee using merchant/POS device 104. Consistent with some embodiments, payment interface application 130 assists with resolving financial transactions through validation, delivery, and settlement. Consequently, payment interface application 130 may be configured to transfer funds to accounts stored in account database 118 to settle indebtedness between users, such as a payor and a payee, by directly or automatically debiting and crediting monetary funds in a manner as accepted by the banking industry. Moreover, payment provider server 106 may be configured to maintain one or more user accounts and merchant accounts in account database 118. For example account information stored in account database 118 may include private financial information of the user or merchant to facilitate payment processing and other financial transactions. Account information stored in account database 118 may further include identity attributes or identity credentials, such as log in information, passwords, or personal identification numbers (PIN), that may be used to initiate, verify, and/or complete a payment transaction.

Payment provider server 106 further includes a network interface component (NIC) 132 configured for communication with network 108. Consistent with some embodiments, NIC 132 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 132 may be configured to interface with a digital subscriber line (DSL) modem, a public switched telephone network (PSTN) modem, an Ethernet device, and/or various other types of wired and/or wireless network communication devices adapted for communication with network 108. Payment provider server 104 may also include one or more databases 134, which may be internal or external to payment provider server 106, for storing and tracking information related to processed transactions and processed payments.

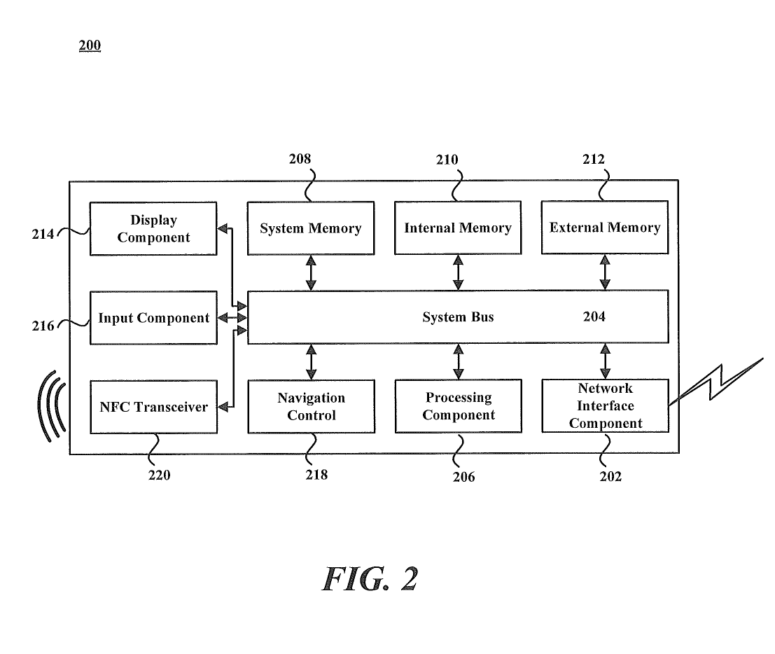

FIG. 2 is a diagram illustrating a device 200 that may correspond to a user/payor device 102 or a merchant/POS device 104, consistent with some embodiments. Device 202 may be a mobile device, such as a smart phone, mobile phone, netbook, notebook computer, tablet computer, or device 202 may be a stationary device such as a desktop computer or a POS workstation or checkout station. As shown in FIG. 2, device 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 202 may be configured to interface with a digital subscriber line (DSL) modem, a public switched telephone network (PSTN) modem, an Ethernet device, and/or various other types of wired and/or wireless network communication devices adapted for communication with network 202.

Consistent with some embodiments, device 200 includes a system bus 204 for interconnecting various components within device 200 and communication information between the various components. Such components include a processing component 206, which may be a processor, micro-controller, or a digital signal processor (DSP), a system memory component 208, which may correspond to random access memory (RAM), an internal memory component 210, which may correspond to read-only memory (ROM), and a static memory 212, which may correspond to optical, magnetic, or solid-state memories. Consistent with some embodiments, device 200 further includes a display component 214 for displaying information to a user of device 200. Display component 200 may be a liquid crystal display (LCD) screen, an organic light emitting diode (OLED) screen, an active matrix OLED (AMOLED), an LED screen, a plasma display, or a cathode ray tube (CRT) display. Device 200 may also include an input component 216, allowing for a user of device 200 to input information to device 200. Such information could include payment information such as an amount required to complete a transaction, account information, verification information, or identification information. An input component 216 may include, for example, a keyboard or key pad. Device 200 may further include a navigation control component 218, configured to allow a user to navigate along display component 214. Consistent with some embodiments, navigation control component 218 may be a mouse, a trackball, or other such device. Moreover, if device 200 includes a touchscreen, display component 214, input component 216, and navigation control 218 may be a single integrated component.

Further consistent with some embodiments, device 200 may include a near field communications (NFC) transceiver 220 for transmitting and receiving information over a NFC protocol. NFC is a set of short-range wireless technologies, typically transmitting over a short distance, such as 4-10 feet. Consistent with some embodiments, NFC operates at a frequency of 13.56 MHz and at rates varying from about 106 kbit/s to about 848 kbit/s. NFC transceiver 220 may be used by device to transmit transaction information over a short distance to a neighboring device having NFC capabilities. For example, as shown in FIG. 1, a user having user device 102 may transmit information from user device 102 to merchant/POS device 104 using NFC protocol. Such information may include payment information, identification information, and/or account information, as will be discussed herein in more detail.

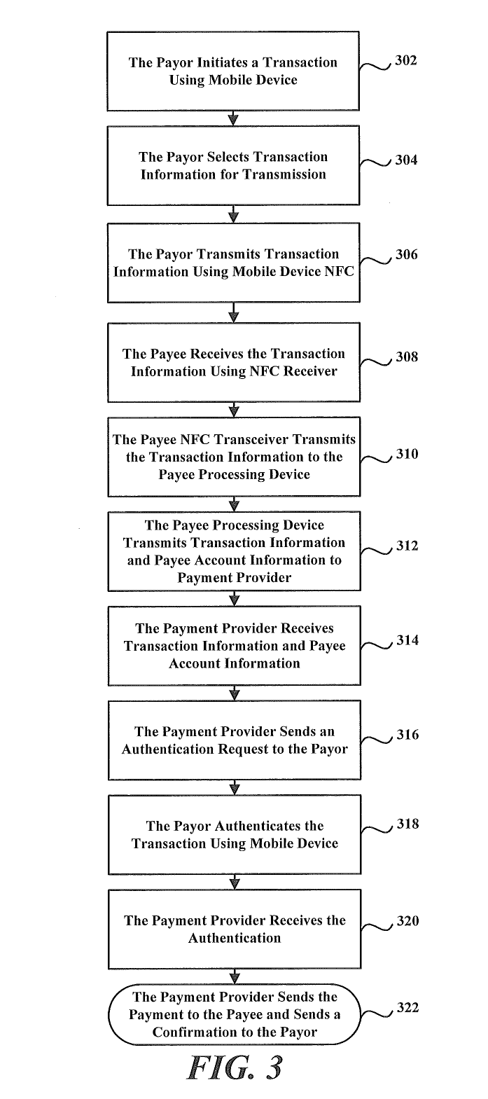

FIG. 3 is a flowchart illustrating a method for conducting a payment transaction using near-field communications, consistent with some embodiments. The method illustrated in FIG. 3 will be described in association with FIG. 1. Consistent with some embodiments, a method as shown in FIG. 3 may allow a payor having a mobile device, such as user device 102 having NFC component 114, payment application 110, and network connectivity through NIC 120 to make payments to a payee having merchant/POS device 104 without having to use paper money, coin money, or a credit card. That is, a method as shown in FIG. 3 may allow a payor to make payments using user device 102 without having to reach into their wallet. Often, a payor may leave their residence and be out shopping but not have their wallet, cash, or their credit card available for use either through forgetfulness or to save space in their pocket or purse. However, payors often will have a mobile device, such as a smart phone, laptop, netbook, or tablet computer with them and, thus, may be able to practice a method as shown in FIG. 3 in order to make payments using one of these devices.

As shown in FIG. 3, the payor first initiates a transaction using a mobile device (302). Consistent with some embodiments, mobile device may be user device 102. Initiating a transaction may include activating payment application 110. The payor then selects the transaction information for transmission to the payee (304). The transaction information may include an authorized amount to pay to a payee, including any transaction fees charged by a payment provider, and payor payment provider account information. Alternatively, the payor may select a preapproval key that preapproves the payment transaction to the payee. Consistent with some embodiments, the payor and the payee may have a payment relationship that is recognized by a payment provider such that transactions or payments up to certain amount are preapproved. Such a preapproval key may allow for faster transactions and payments between payor and payee. After selecting the transaction information, the payor transmits the selected transaction information to the payee using the near-field communications transceiver 114 of user device 102 (306). The transmitted transaction information is then received at merchant/POS device 104 by NFC transceiver 128 (308). The received transaction information is then transmitted to processing device 126 (310). As noted above, consistent with some embodiments NFC transceiver 128 may be incorporated in a PIN pad or other transaction device that is coupled to a processing device 126 that may be a POS device such as a cash register or a personal computer. However, according to other embodiments, NFC transceiver 128 may be incorporated in merchant processing device 126 such as in a mobile device and, in such embodiments, step 310 is understood as being a local transmission.

Returning to FIG. 3, after receiving transaction information, merchant interface application 122, which may be computer-readable instructions stored on merchant processing device 126, causes the transmission of the received transaction information along with payee payment provider account information to payment provider server 106 over network 108 (312). Payment provider server 106 receives the transaction information and payee account information (314). Consistent with some embodiments, the method illustrated in FIG. 3 may have additional security features, such as payor authentication, in order to prevent fraudulent payment transactions. Accordingly, payment provider server 106 may send an authentication request to the payor (316). The authentication request may be processed by payment application 110 and result in a notification at user device 102 requesting payor authorization. Alternatively, the request for authentication may be a short messaging service (SMS) message sent to user device 102 requesting a reply to authorize the transaction, or an e-mail sent to a known e-mail address of payor. If the payor authenticates the transaction by replying to the notification, SMS message, or e-mail (318), payment provider server 106 receives the authentication (320) and sends the payment to the payee and a confirmation message to the payor (322). Consistent with some embodiments, sending the payment to the payee may include depositing funds in a payee's account stored in account database 118, or crediting funds to a payee's account stored in account database 118, both while debiting a payor's account stored in account database for the payment amount and any additional transaction fees. Further consistent with some embodiments, sending a confirmation message may include sending an SMS message, an e-mail, or a data-based notification that is interpreted by payment application 110 executing on user device 102, any of which displays the transaction amount, payee information, and, optionally, a confirmation number.

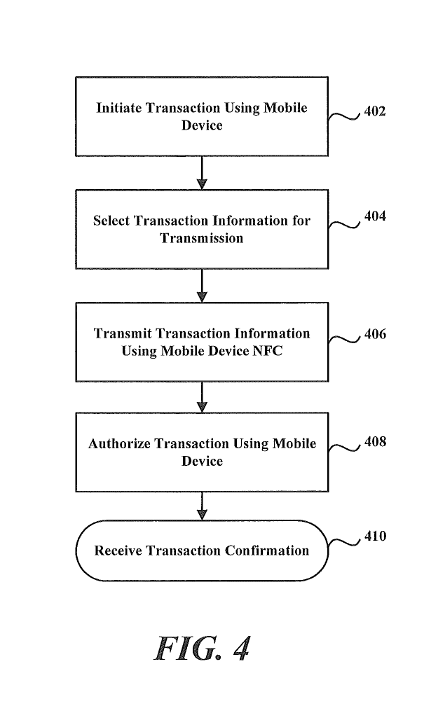

FIG. 4 is a flowchart illustrating a method for paying a payee by a payor consistent with some embodiments. The method illustrated in FIG. 4 will be described in association with FIGS. 1 and 2. In the context of discussing the method illustrated in FIG. 4, it will be assumed that device 200 corresponds with, and is interchangeable with, user device 102 shown in FIG. 1. Further, the method illustrated in FIG. 4 may correspond to the actions shown in FIG. 3 that are performed only by the payor. Consistent with some embodiments, a method as shown in FIG. 4 may allow a payor having a mobile device, such as user device 102 having NFC component 114, payment application 110, and network connectivity through NIC 120 to make payments to a payee having merchant/POS device 104 without having to use paper money, coin money, or a credit card. That is, a method as shown in FIG. 4 may allow a payor to make payments using user device 102 without having to reach into their wallet. Often, a payor may leave their residence and be out shopping but not have their wallet, cash, or their credit card available for use either through forgetfulness or to save space in their pocket or purse. However, payors often will have a mobile device, such as a smart phone, laptop, netbook, or tablet computer with them and, thus, may be able to practice a method as shown in FIG. 4 in order to make payments using one of these devices.

Returning to FIG. 4, a payor first initiates a transaction using a mobile device (402). Consistent with some embodiments, mobile device may be user device 102. Initiating a transaction may include activating payment application 110. The payor then selects the transaction information for transmission to the payee (404). The transaction information may include an authorized amount to pay to a payee, including any transaction fees charged by a payment provider, and payor payment provider account information. Alternatively, the payor may select a preapproval key that preapproves the payment transaction to the payee. Consistent with some embodiments, the payor and the payee may have a payment relationship that is recognized by a payment provider such that transactions or payments up to certain amount are preapproved. Such a preapproval key may allow for faster transactions and payments between payor and payee. After selecting the transaction information, the payor transmits the selected transaction information to the payee using the near-field communications transceiver 114 of user device 102 (406). Consistent with some embodiments, the method illustrated in FIG. 4 may have additional security features, such as payor authorization, in order to prevent fraudulent payment transactions. Accordingly, the payor have an opportunity to authorize the transaction using user device 102. For example, payment provider server 106 may send an authorization request to the payor. The authorization request may be processed by payment application 110 and result in a notification at user device 102 requesting payor authorization. Alternatively, the request for authorization may be a short messaging service (SMS) message sent to user device 102 requesting a reply to authorize the transaction, or an e-mail sent to a known e-mail address of payor. The payor can then authorize the transaction by replying to the notification, SMS message, or e-mail (408). Then, once the payment has been processed, the payor receives a confirmation message to the payor (410). Consistent with some embodiments, the confirmation message may include an SMS message, an e-mail, or a data-based notification that is interpreted by payment application 110 executing on user device 102, any of which displays the transaction amount, payee information, and, optionally, a confirmation number.

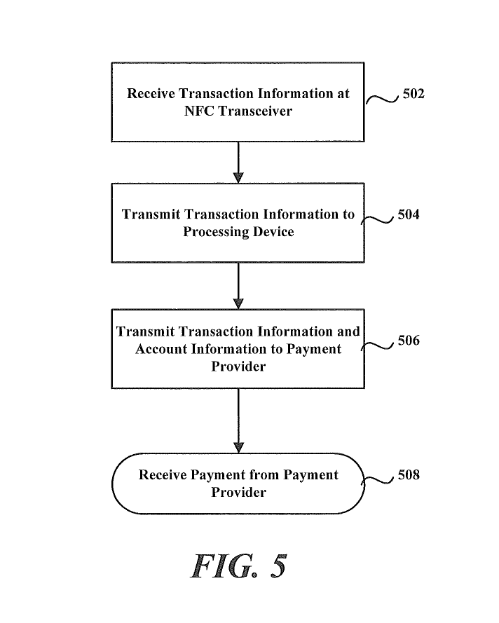

FIG. 5 is a flowchart illustrating a method for receiving payment from a payor, consistent with some embodiments. The method illustrated in FIG. 5 will be described in association with FIGS. 1 and 2. In the context of discussing the method illustrated in FIG. 5, it will be assumed that device 200 corresponds with, and is interchangeable with, merchant/POS device 104 shown in FIG. 1. Further, the method illustrated in FIG. 5 may correspond to the actions shown in FIG. 3 that are performed only by the payee. Consistent with some embodiments, a method as shown in FIG. 5 may allow a payee having a merchant/POS device 104 having NFC transceiver 128, merchant interface application 122, and network connectivity through NIC 124 receive payments from a payor. Further consistent with some embodiments, the payor may be making payments using user device 102 in accordance with the methods illustrated in FIGS. 3 and 4. As shown in FIG. 5, the method begins when the payee receives an transaction information (502). Consistent with some embodiments, the transaction information is transmitted using NFC and is received by NFC transceiver 128. The transaction information may include an authorized amount to be paid the payee, including any transaction fees charged by a payment provider, and may also include payor payment provider account information. Alternatively, the transaction information may include a preapproval key that preapproves the payment transaction to the payee. The received transaction information is then transmitted to processing device 126 (504). As noted above, consistent with some embodiments NFC transceiver 128 may be incorporated in a PIN pad or other transaction device that is coupled to a processing device 126 that may be POS device such as a cash register or a personal computer. However, according to other embodiments, NFC transceiver 128 may be incorporated in merchant processing device 126 such as in a mobile device and, in such embodiments, step 504 is understood as being a local transmission.

After receiving the transaction information from the NFC transceiver 128, merchant interface application 122, which may be computer-readable instructions stored on merchant processing device 126, causes the transmission of the received transaction information along with payee payment provider account information to payment provider server 106 over network 108 (506). Following authentication and other actions performed by a payor or payment provider server, payee receives payment from the payment provider (506).

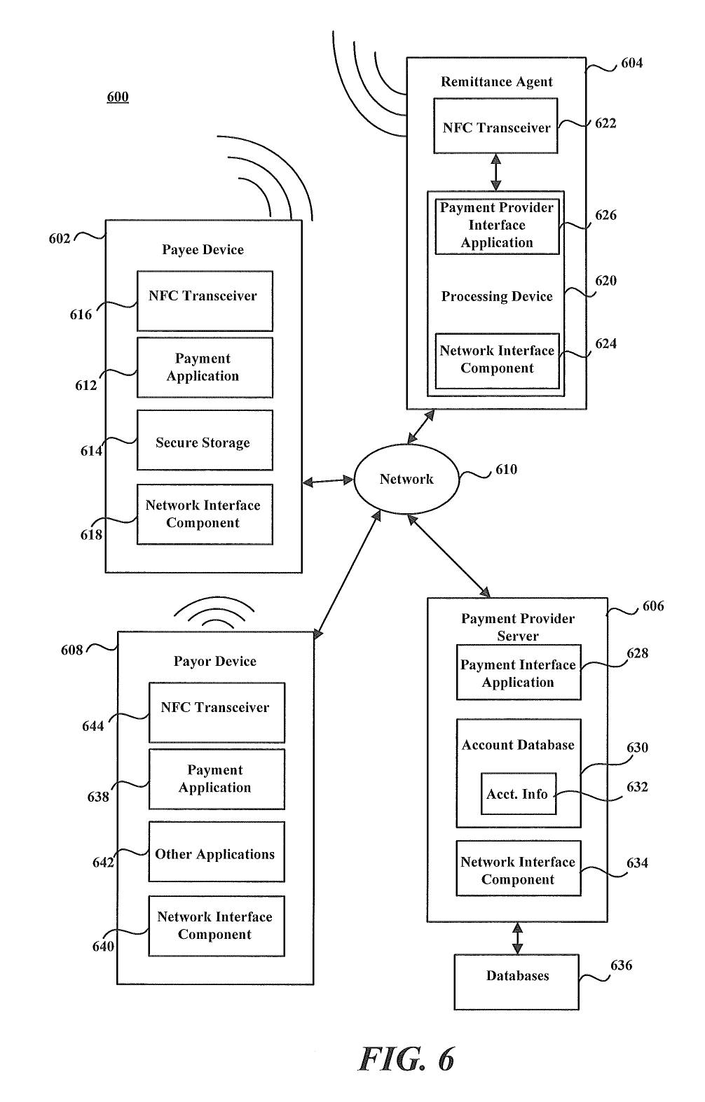

FIG. 6 is a block diagram of a system for facilitating and performing financial transactions, such as a payment between a payor and a payee through the use of a remittance agent, consistent with some embodiments. As shown in FIG. 6, system 600 includes a payee device 602, a remittance agent device 604, a payment provider server 606, and a payor device 608 all coupled to network 610. Consistent with some embodiments, network 610 may be similar to network 108 and, thus, include similar features as network 108.

Consistent with some embodiments, payee device 602, remittance agent device 604, payment provider server 606, and payor device 608 may include any appropriate combination of hardware and/or software having a processor and capable of reading instructions stored on a non-transitory machine-readable medium for execution by the processor and may be configured for wired and/or wireless communication over network 610. According to some embodiments, any of payee device 602, remittance agent device 604, and payor device 608 may be a mobile device, such as a mobile phone, a smart phone, or a tablet computer such as the Apple™ iPad™. According to other embodiments, any of payee device 602, remittance agent device 604, and payor device 608 may be a processing device such as a personal computer, a personal digital assistant (PDA), or a notebook computer.

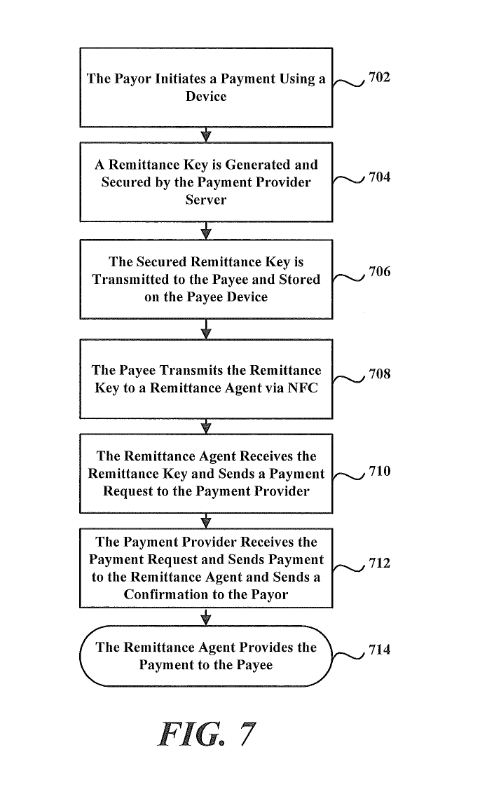

Consistent with some embodiments payee device 602 includes a machine-readable medium, such as a memory (not shown) that includes instructions for execution by a processor (not shown) for causing payee device 602 to perform specific tasks. For example, such instructions may include a payment application 612, secure storage 614, an NFC transceiver 616, and a network interface component (NIC) 618. Consistent with some embodiments, payment application 612 may be utilized by a payee to conduct network based financial transactions, (e.g., remote network based commerce, such as shopping, purchasing, bidding, etc.) with any of payor device 608, remittance agent 604, or payment provider server 606 over network 610. Consistent with some embodiments, secure storage 614 may be an encrypted data store in a section of physical memory in payee device 602. According to other embodiments, secure storage 614 may refer to instructions that, when executed by a processor of payee device 602, cause the processor to secure data using encryption, passwords, and other security features to ensure that only a user of payee device having the proper knowledge or proper credentials is able to access any data stored in, or using, secure storage 614. Also consistent with some embodiments, payment application 612 may be used by a payee to process a received remittance key, as will be discussed in greater detail with respect to FIG. 7. Further consistent with some embodiments, a remittance key is an encrypted alphanumeric key that includes payment transaction information which allows a payor to make a payment, or simply send money, to a payee using a third party remittance agent and a payment provider server. The payment transaction information may include an amount to be paid and a payor's payment provider account information.

Returning to FIG. 6, remittance agent device 604 includes a processing device 620 coupled to an NFC transceiver 622, a NIC 624, and a payment provider interface application 626. Although NFC transceiver 622 is shown in FIG. 6 as being separate from, and coupled to, processing device 620, consistent with some embodiments, NFC transceiver 622 may be contained with processing device 620. Payment provider interface application 626 includes instructions for execution by processing device 620 that, when executed, allows a remittance agent using remittance agent device 604 to conduct transactions with payment provider server 606. Consistent with some embodiments, payment provider interface application 626 may include instructions for processing a received remittance key from payee device, sending payment request to payment provider server 606 over network 610 using NIC 624, and receiving a payment from payment provider server 606, as discussed in greater detail in FIG. 7.

Payment provider server 606 is similar to payment provider server 106 shown in FIG. 1. In particular, payment provider server 606 includes a payment interface application 628, an account database 630 having account information 632 stored therein, and a network interface component (NIC) 634 allowing payment provider server 606 to communicate over network 610. Payment provider server 606 may also be connected to at least one database 636 for storage of payment information, account information, and other related information. Consistent with some embodiments, payment provider server 606 may be provided by PayPal, Inc. and/or eBay of San Jose, Calif., USA. Payment interface application 628 may include a payment processing module to process payments of purchases for financial transactions between payors and payees and may assist with resolving financial transactions through validation, delivery, and settlement. Consequently, payment interface application 628 may be configured to transfer funds to accounts stored in account database 630 to settle indebtedness between payors and a payees, or payees and a remittance agent by directly or automatically debiting and crediting monetary funds in a manner as accepted by the banking industry.

Payor device 608 is similar to payee device 602 in that it includes a payment application 638 and a network interface component 640. Consistent with some embodiments, payor device 608 may also include other applications 642 and an NFC transceiver 644. Payor device 608 may be a mobile device, such as a smart phone or tablet computer. Alternatively, payor device 608 may be a laptop or personal computer. Consistent with some embodiments, payment application 638 may be utilized by a payor to conduct financial transactions, such as a payment, wherein the payor may have an account 632 stored in an account database 630 on payment provider server 606 for the direct and/or automatic payment, exchange of funds, or remittance of money between a payor and a payee.

According to some embodiments, payment application 638 includes instructions for execution by a processor, such as a software program, that provides a graphical user interface (GUI) for interfacing and communicating with a payor, a payee having payee device 602, and payment provider server 606 via network 108 or NFC Transceiver 644. Consistent with some embodiments, payment application 638 may allow a payor to enter payment information, payee account information, a payment amount, a user's credit card or bank account information, a payee name or other credentials, or other related information that may permit a payor to make a payment to a payee through payment service provider 606. According to some embodiments, payment application 638 may be a mobile application executing on payor device 608 however, according to other embodiments, payment application 638 may be a web browser that allows the payor to interact with payment provider server 606 to allow a payor to pay, or send money to, a payee, as described further in FIG. 7.

FIG. 7 is a flowchart illustrating a method for remitting a payment to a payee using a remittance agent, consistent with some embodiments. The method illustrated in FIG. 7 will be described in association with FIG. 6. Consistent with some embodiment, a method as shown in FIG. 7 may allow a payor an account with a payment provider to provide a payment to a payee, or otherwise send, transfer, or “wire” money to a payee, without the payee needing to also have an account with the payment provider. As shown in FIGS. 6 and 7, a payee having a payee device 602 may be able to redeem a received remittance key for money at a remittance agent.

As shown in FIG. 7, the method begins when the payor initiates a payment using a device such as payor device 608 (702). As discussed above, initiating a payment using payor device 608 may involve using payment application 638, which may be a mobile application executing on a mobile payor device or a web browser allowing the payor to interact with payment provider server 606. Consistent with some embodiments, the payor uses payment application 632 to enter transaction information for the generation of a remittance key. The transaction information may include information about the payor, information about the payee, a payment amount (including any transaction fees charged by the payment provider), and the payee's payment provider account information. The information about the payee may include personal details, or simply credentials allowing the transmittance of the remittance key to payee device 602. Such credentials may include a phone number, an e-mail address, or payee account information associated either with the payment provider or, for example, a secure storage provider.

After the payor initiates the payment, a remittance key is generated and secured by payment provider server 606 (704). Consistent with some embodiments, generating and securing the remittance key may include receiving the payment information and payee information from payor device 608 over network 610 and, generating an encrypted alphanumeric key that includes the payment information. The secured remittance key is then transmitted to payee device 602 and stored thereon (706). Consistent with some embodiments, the remittance key may be stored in secure storage 614 of payee device. Secure storage 614 may be an encrypted data store in a section of physical memory in payee device 602 or instructions that, when executed by a processor of payee device 602, cause the processor to secure data using encryption, passwords, and other security features to ensure that only a user of payee device having the proper knowledge or proper credentials is able to access any data stored in, or using, secure storage 614.

Once the payee has received the remittance key, the payee may then take the stored remittance key to a remittance agent, and transmit the remittance key to remittance agent device 604 using NFC transceiver 616 (708). Remittance agent device 604 receives the transmitted remittance key at NFC transceiver 622, transmits the received remittance key to processing device 620 and, using payment processing application 626, processes the received remittance key to send a payment request to payment provider server 602 over network 610 (710). Payment provider server 606 receives the transmitted payment request, processes the payment request using payment interface application 628 and sends payment to the remittance agent and a confirmation to the payor (712). Sending the payment to the remittance agent may include depositing funds in a remittance agent's account stored in account database 630, or crediting funds to a remittance agent's account stored in account database 630, both while debiting a payor's account stored in account database 630 for the payment amount and any additional transaction fees. Further consistent with some embodiments, sending a confirmation message to the payor may include sending an SMS message, an e-mail, or a data-based notification that is interpreted by payment application 638 executing on payor device 608, any of which displays the transaction amount, payee information, and, optionally, a confirmation number. The remittance agent then provides the payment to the payee (714). Consequently, the method shown in FIG. 7 may allow a payor having an account with a payment provider to send money to a payee, such that the payee can conveniently go to the nearest remittance agent that also has an account with the payment provider and receive the money. Consistent with some embodiments, the remittance agent can be any entity with a payment provider account, and may include a store, a market, a bank, a check-cashing service, or a telegraph service provider.

Consequently, embodiments as described herein may provide methods for using devices having network or near-field communications capabilities to facilitate making and receiving payments through a payment provider. Such embodiments may allow a payor to complete payment transactions without having to use traditional means of currency and, thus, alleviating the user from having to reach into their purse or wallet for currency, or in some cases, carry their purse or wallet at all. Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A non-transitory computer-readable medium having instructions for execution by a processor, the instructions causing the processor, when executed, to perform a method comprising:
receiving transaction information from a payee, the transaction information provided to the payee by a payor using near-field communications and including a payment amount and payee account information;
sending a transaction authentication request to the payor;
receiving a transaction authentication from the payor;
sending the payment amount to the payee; and
sending a payment confirmation to the payor.

2. The computer-readable medium of claim 1, wherein the transaction information includes an approved payment amount and a payor's account information.

3. The computer-readable medium of claim 1, wherein sending a payment confirmation comprises sending at least one of an e-mail, a short messaging services (SMS) message, or a specific notification to the payor over a network.

4. The computer-readable medium of claim 1, wherein the transaction information provided to the payee by a payor is provided using near-field communications capabilities of a payor's mobile device.

5. The computer-readable medium of claim 1, wherein the transaction information comprises a preapproval key preapproving the payment to the payee.

6. The computer-readable medium of claim 5, wherein the preapproval key includes a preapproved amount that the user is preapproved to pay the payee.

7. The computer-readable medium of claim 1, wherein the transaction information is encrypted.

8. A non-transitory computer-readable medium having instructions for execution by a processor of a mobile device, the instructions causing the processor, when executed, to perform a method comprising:
initiating a payment transaction to a payee;
selecting information related to the payment transaction for transmission;
transmitting information related to the payment transaction to the payee, wherein the information is transmitted using near field communication (NFC) capabilities of the mobile device;
authorizing a payment provider to perform the payment transaction in response to a authentication request received from the payment provider; and
receiving, at the mobile device, a confirmation of the payment transaction from the payment provider.

9. The method of claim 8, wherein the information related to the payment transaction includes at least one of an approved payment amount, a designated payment provider, and a user's payment provider account information.

10. The method of claim 8, wherein the confirmation of the payment transaction comprises at least one of an e-mail, a short messaging services (SMS) message or a specific notification received over a network.

11. The method of claim 8, wherein selecting information related to the payment transaction for transmission comprises:
selecting a preapproval key preapproving the payment transaction to a payee.

12. The method of claim 11, wherein the preapproval key includes a preapproved amount that the user is preapproved to pay the payee.

13. The method of claim 8, wherein selecting information related to the payment transaction for transmission comprises:
selecting payment provider account information of the user.

14. The method of claim 8, wherein the transmitted information is encrypted.

15. A non-transitory computer-readable medium having instructions for execution by a processor, the instructions causing the processor, when executed, to perform a method comprising:
generating a remittance key, the remittance key including an encrypted alphanumeric key having a payment amount and payment provider account information for a payor;
transmitting the remittance key to a payee;
receiving a payment request from a remittance agent, the payment request including the remittance key transmitted from the payee to the remittance agent using near field communications; and
transmitting a payment amount to a remittance agent.

16. The computer-readable medium of claim 15, wherein transmitting the remittance key comprises:
transmitting the remittance key to the payee using a short messaging service (SMS) message; or
transmitting the remittance key to the payee as processor-executable instructions that, when executed by a payee's processor, causes the remittance key to be securely stored in a memory coupled to the payee's processor and further causes a notification of the storage of the remittance key to be displayed to the payee.
